(19) United States
(12) Patent Application Publication
(10) Pub. No.: US 2015/0200554 A1
(43) Pub. Date: Jul. 16, 2015

(54) CHARGEABLE, PORTABLE STORAGE CASE FOR OPTICAL AND OTHER WEARABLE COMPUTING DEVICES

(71) Applicants: JEFFREY S. MARKS, NEWPORT COAST, CA (US); BENJAMIN S. MARKS, NEWPORT COAST, CA (US)

(72) Inventors: JEFFREY S. MARKS, NEWPORT COAST, CA (US); BENJAMIN S. MARKS, NEWPORT COAST, CA (US)

(21) Appl. No.: 14/594,106

(22) Filed: Jan. 10, 2015

Related U.S. Application Data
(60) Provisional application No. 61/925,667, filed on Jan. 10, 2014.

(51) Int. Cl. H02J 7/00; H02J 7/02

(52) U.S. Cl. CPC H02J 7/0042; H02J 7/025

(57) ABSTRACT

A portable case for optical and other wearable computing devices comprises a receptacle forming a storage compartment, an internal rechargeable battery, electrical components, and one or more ports. The portable case further includes a charger and a mount for a rechargeable battery. Modules providing supplementary computer storage device or RAM may be further included in the portable case as embedded components to provide the optical and other wearable computing device with additional or auxiliary electronic storage.

### CROSS-REFERENCE TO RELATED PATENT APPLICATIONS

This patent application claims priority to U.S. provisional application 61/925,667, filed on Jan. 10, 2014, the contents of which are incorporated in their entirety herein.

### FIELD OF THE INVENTION

The present invention relates to wearable electronic and computing devices. Specifically, the present invention is a portable case for storing wearable electronic and computing equipment, such as optical computing devices in the form of eyewear, headgear, or other wearable items that incorporates an auxiliary battery capable of charging the wearable electronic and computing device. The auxiliary battery may itself be recharged through a port that connects to an external power source. The portable case may also incorporate additional computing storage components such as random access memory (RAM) modules.

### BACKGROUND OF THE INVENTION

It is well known in the art that mobile devices such as mobile telephones and personal digital assistants (PDAs) come with an internal battery which is used to power the mobile device. However, such internal batteries are known to have a limited life. To provide additional power, for at least mobile telephones, external battery cases such as those disclosed in U.S. Pat. Nos. 8,390,255, 8,013,572 and 7,889,498, 7,638,969 and 7,612,997 provide additional battery life to the mobile device.

New technology is being developed which is incorporating computers into wearable devices such as eyeglasses and headgear. An example is Google Glass, which incorporates a computing device and small display screen into an eyeglass apparatus. Such wearable electronic devices are fragile and carry valuable personal information. It is anticipated that users will store and carry such electronic devices in portable cases. In addition, due to the size of the devices, their internal batteries have a very limited life and there is limited storage capacity.

Therefore, it is desirable to increase the battery life of electronic portable computing devices and also to protect these devices from damage when being stored and transported. It is also desirable for such portable cases to incorporate additional storage to increase their memory and computing capacity. The aforementioned prior art does not teach or disclose a case that is capable of (a) fitting and protecting wearable electronic and computing devices such as optical equipment, (b) simultaneously providing a method for recharging the batteries powering those wearable electronic and computing devices, and (c) incorporating additional storage capacity for such devices.

### BRIEF SUMMARY OF THE INVENTION

Accordingly, it is an object of the present invention to provide a sturdy portable case to house and protect wearable electronic computing devices such as eyeglasses and headgear, which is also capable of recharging such devices and incorporating additional storage capacity for such devices.

An aspect of at least one of the embodiments disclosed herein includes the realization that computing power is evolving into wearable electronic and computing devices such as optical equipment, headgear, and other such computing apparatuses, that such devices may be fragile and will have limited power that must be recharged. Another aspect includes the realization that such devices will benefit from a portable carrying case which offers protection and simultaneously provides a means for recharging the batteries within such devices.

For example, the present invention may comprise a case for optical computing devices, which is molded to the contour of the device such that the device fits snugly within the case so as to protect it when not in use and during transportation. The internal portion of the case may include electrical components and a rechargeable auxiliary battery, and a port or jack which is linked to the auxiliary battery, which may receive or be plugged into a charging jack or port on the electronic device. The case may also include a rechargeable battery charger configured to recharge the auxiliary battery within the case from an outside power source which may include a wall outlet, a computer, or a secondary portable charging device. The present invention may also include at least one charging cable configured to connect the case with a power source, and at least one connector configured to connect the charging cable with the case. The case may also comprise a jack or port which can plug directly into an external computer such as a desktop, laptop, mobile computing device or other secondary computing device, and which can establish a connection between and synchronize and/or transfer data between the wearable electronic computing device and the external computer.

In accordance with another embodiment, the present invention may also incorporate external storage or RAM for the wearable electronic computing device. The case may also include a jack or port for connecting such external storage or RAM to the device.

Other embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a perspective view of an exemplary portable case according to the present invention; and

FIG. 2 is a perspective view of an exemplary portable case according to one embodiment of the present invention.

### DETAILED DESCRIPTION OF THE INVENTION

The instant disclosure describes several embodiments of the present invention. However, one should keep in mind several points. First, the described embodiments present what the inventor(s) believe to comprise the best mode for practicing the invention at the time this patent application was filed. Thus, one of ordinary skill in the art may recognize from the following embodiments that substantially equivalent structures, acts or methods may be used or combined to achieve the same results in exactly the same way, or to achieve the same results in a not dissimilar way. Therefore, the following embodiments should not be interpreted as limiting the invention to the embodiments specifically described. For example, one recognizes that the systems and methods described herein can be applied to other fragile wearable electronic and computing devices which require customizable, specialized, and/or fitted cases for protection and which have rechargeable batteries, such has headgears, helmets, wristwatches, wristwatch computers, hearing aids and audio devices. In addition, one recognizes that this disclosure can be applied to different styles and configurations of cases that house such wearable electronic and computing devices. For example, differently-shaped wearable electronic optical computing devices, or other electronic headgear or similar equipment may require differently-configured or shaped cases in order to snugly house and protect the device, and the same are intended to be within the scope of this application. In addition, different electronic and computing devices may have data and power ports located in different areas on the device, and the apparatus disclosed herein should be construed to encompass locating the connectors in different locations in the receptacle within the apparatus.

Likewise, individual aspects of the present invention are provided as examples, and, accordingly, one of ordinary skill in the art may recognize from a disclosed structure or act that a substantially equivalent structure or act may be used to either achieve the same results in substantially the same way, or to achieve the same results in a not dissimilar way. For example, the present disclosure refers to battery power. This, however, may be extended to apply to other sources of rechargeable power that may be embedded into mobile devices.

Furthermore, it is recognized that as technology develops, a number of additional alternatives to achieve an aspect of the invention may arise, including, but not limited to, the methods for recharging internal batteries within mobile devices. For example, apparatuses for charging mobile devices wirelessly have been invented, and the same are intended to be covered herein. Such advances are within the scope of the present invention, and should be recognized as being functionally equivalent or structurally equivalent to the aspect shown or described herein.

In addition, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

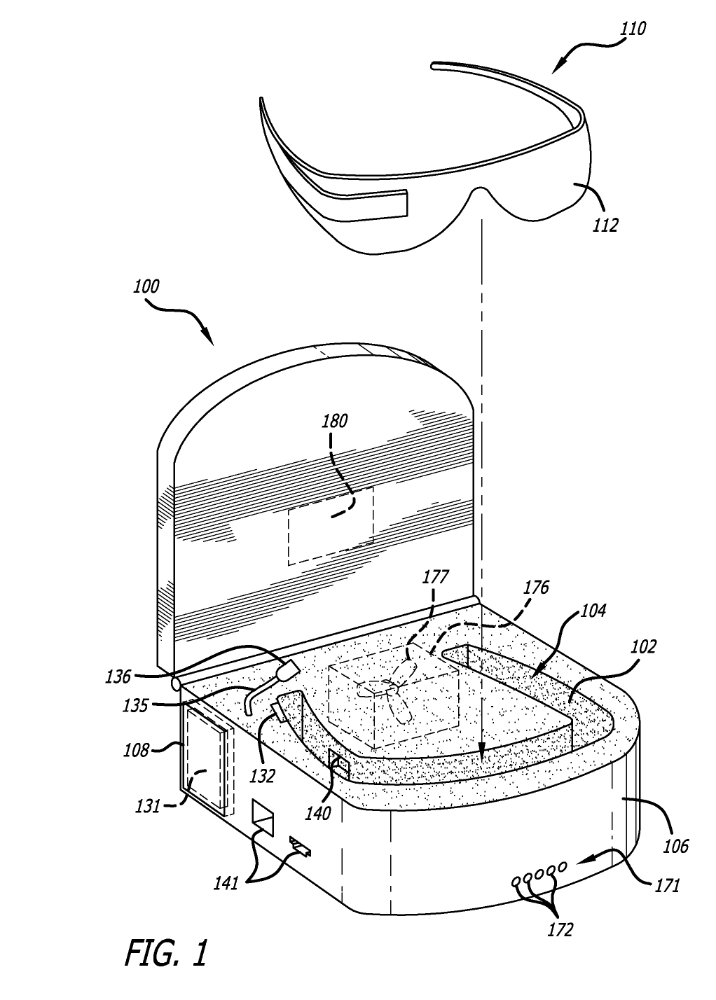

FIG. 1 is a perspective view of the present invention, which is, in one embodiment, a portable case 100 within which a wearable electronic and/or computing device 110, such as an optical computing device 112 having a head-mounted display in the form of eyewear or eyeglasses, may be housed. The portable case 100 comprises a receptacle 102 configured to receive and hold the optical computing device 112 having a main battery 120, and charging components 130 that include an auxiliary battery 131 embedded within the portable case, and at least one electrical contact 132 within the receptacle 102. The electrical contact 132 is operable to electrically connect the auxiliary battery 131 to the optical computing device 112 so that a charge of the auxiliary battery 131 may be applied to the main battery 120 when stored within the receptacle 102 on an inside 104 of the portable case 100.

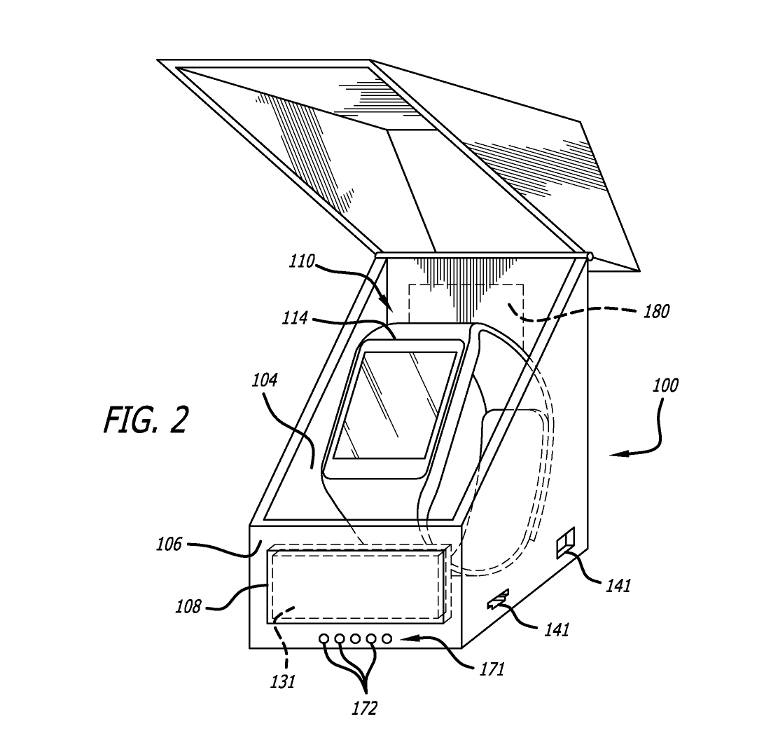

The present invention, as noted above, is applicable to any type of wearable electronic and/or computing device 110. For example, the wearable electronic and/or computing device 110 may include devices having an optical head-mounted display, such as eyewear and eyeglasses 112, and other equipment to be worn, particularly on or around the head. Other examples include helmets, audio devices, hearing aids, and devices worn around the head or upper body while playing, manipulating or actuating an electronic and/or computerized game, virtual reality system, or other device, and the like. It should be noted that the wearable and/or electronic computing device 110 may include other wearable electronic items, such as for example eyeglasses equipped with video recording equipment. It is therefore to be understood that any wearable electronics are to be including within the scope of the present invention. The present invention is also applicable to equipment that is to be worn on other parts of the body, such as a wristwatch 114. FIG. 2 is a perspective of the portable case 100 according to such an embodiment, where a wristwatch 114 is capable of being stored therein.

In another embodiment, the present invention may be considered as a portable recharging device for housing electronic eyeglasses 112 or other wearable electronic and/or computing devices 110. The portable recharging device is configured within a portable case 100 and comprises an auxiliary battery 131 and includes a receptacle 102 which receives and holds electronic eyeglasses 112 having a main battery 120, and at least one electrical contact 132 within the receptacle 102 on an inside 104 of the portable case 100. The electrical contact 132 is operable to electrically connect the auxiliary battery 131 to the eyeglasses 112 so that power from the auxiliary battery 131 may be applied to the main battery 120 of the eyeglasses 112.

In still another embodiment, the present invention comprises a method for recharging a wearable electronic and/or computing device 110, such as eyeglasses 112. Such a method at least includes the steps of coupling the wearable electronic and computing device 110 to one or more ports 140 within a receptacle 102 configured to store the wearable electronic and/or computing device 110 when not in use, or when being transported, inside a portable case 100. The receptacle 102 is further configured with a rechargeable battery 131 disposed therein for the purpose of providing power to charge a main battery 120 affixed to the wearable electronic and/or computing device 110.

Regardless of the embodiment, the present invention may include many other elements. For example, the rechargeable, auxiliary battery 131 may be housed within in a second receptacle 108 within the portable case 100, and therefore may be removable and replaceable. Additionally, the portable case 100 may include at least one electrical contact 132 within the receptacle that is attached to a small cable or cord 150 that can be used to connect the rechargeable, auxiliary battery 131 to the optical computing device 112 where a port 113 on the optical computing device 112 is not configured in a location that can be easily snapped into place upon insertion on the inside 104 of the portable case 100.

The portable case 100, the receptacle 102, the second receptacle 108, and other aspects of the case 100 may be molded or configured in various shapes, depths, and dimensions to accommodate the specific items to be securely held therein. For example, the second receptacle 108 may be molded to have to the specific size, shape and dimensions of the auxiliary battery 131 to be used to charge the optical computing device 112 to be placed within the portable case 100.

The present invention may further include an extension cable or cord 160 that lengthens the connection between the optical computing device 112 and the rechargeable auxiliary battery 131, such that the optical computing device 112 may be used while the rechargeable, auxiliary battery 112 is charging the main battery 120.

Charging circuitry 133 may also be included in the present invention. This charging circuitry 113 may be part of, and housed within, the charging components 130. The charging components 134 may also include additional, external contacts 134 or means to charge the optical computing device 112. The charging components 130 may also comprise a charging cable 135 to connect the portable case 100 with a power source. One such power source may be a computer, which is employed to convey power to the portable case 100 therefrom.

The portable case 100 may further include one or more external ports 141 configured on the outside 106. These external ports 141 enable connection with an external power source, so that the auxiliary battery 131 may itself be recharged. Such ports 141 may be of any type that is commonly used to serve as an interface between computers or peripheral devices, such as for example (but not limited to) E-Sata, USB, IEEE 1394 interface (FireWire), serial, PS/2, etc.

The additional, external contacts 134 may, in one embodiment, include one or more metal contacts, on either the eyeglasses 112, on the inside 104 of the portable case 100, or both, so that the eyeglasses 112 are able to automatically contact with a connector to the auxiliary battery 131. These one or more metal contacts provide a charge for the main battery 120 without any components needing to be actually plugged in or connected via a wire or cable to provide power for the main battery 120.

The present invention may also include a data cable 136 configured to connect the portable case 100 with a computer and enable data to be synchronized between the computer and optical computing device 112. The charging cable 135 and the data cable 136 may be integrated, so that both charging and data synchronization functions are performed by the same cable. The charging cable 135 and/or the data cable 136 may be connected to the computer or external power source via the external ports 141.

The present invention may further comprise additional electronic circuitry 170 that implements a battery status feature 171. This electronic circuitry 170 may include a plurality of light emitting diodes 172, which are visible on an outside 106 or inside 104 (or both) of the portable case 100 to display an indication 173 of battery strength and charging status to a user. The battery status feature 171 may be configured to provide the indication 173 of battery strength of one or both of the main battery 120 and the auxiliary battery 131.

The present invention may also incorporate different types of wireless systems. One such wireless system includes a means of wirelessly charging one or both of the main battery 120 and the rechargeable, auxiliary battery 131, so that no cable is needed to enable the charging of one or both of the main battery 120 and rechargeable, auxiliary battery 131. A plurality of wireless components 174 may be employed to accomplish the wireless performance of the present invention.

Another wireless system that may be included in the present invention is a means for wirelessly connecting the portable case 100 to the Internet using a Wi-Fi network 175. In one additional embodiment, the wireless components 174 include circuitry 174 that enables the optical computing device 112 to connect with and communicate data over the Internet when stored in the portable case 100 by connecting to a Wi-Fi network 175, so that mobile network usage charges are not incurred while latent data transfers occur when the optical computing device 112 is stored in the receptacle 102. In another embodiment, the circuity 174 and wireless components thereof may also enable the portable case 100 of the present invention to be configured as a Wi-Fi “hotspot” (as a location that offers Internet access over a wireless local area network (WLAN)) or tethering device for the optical computing device 112 when it is not stored within the receptacle 102.

The present invention may also include means for cooling 176 equipment within the portable case 100, such as a fan or other heat dissipation device. Such a means for cooling 176 may be disposed within the receptacle 102 and proximate to the rechargeable, auxiliary battery 131 or charging circuitry 133 to prevent over-heating within the portable case 100.

The present invention may also include additional computer memory modules, storage components or RAM 180 on the inside 104 of the portable case 100 to supplement the memory, storage or RAM included within or on board the optical computing device 112. It is contemplated that the present invention may further comprise a second electrical contact 181 within the receptacle 102 that is operable to electrically connect the auxiliary memory module(s), computer storage or RAM 180 to the optical computing device 112. An extension cord 182 that lengthens the connection between a port 113 of the optical computing device 112 and the auxiliary storage or RAM 180 within the portable case 100 may also be included, such that the optical computing device 112 may be used while the auxiliary memory, storage or RAM 180 is connected.

It should be noted that the one or more of the auxiliary memory module(s), computer storage or RAM 180 may also include cloud-based components or components resident in a distributed computing environment that the present invention wirelessly connects with, using the Wi-Fi network 175 and related components 174, or via a mobile data network such as a 3G or 4G network. The auxiliary memory module(s), computer storage or RAM 180 may be a combination of components resident within the portable case 100 and those or which the present invention connects with wirelessly.

The rechargeable, auxiliary battery 131 may also be configured to conform in shape to at least at portion of the portable case 100, so that the shape of the rechargeable, auxiliary battery 131 is at least partially the same as that of the portable case 100 to reduce the size of the case 100 and make it easier for users to transport, such as in a handbag, backpack or pocket. The portable case 100 may also include components that enable the case 100 to mate with a receptacle inside a car or vehicle to connect with electronic components in the vehicle to charge the rechargeable, auxiliary battery 131 or otherwise use on-board computer systems, such as those capable of connecting to the Internet. The portable case 100 may have an external attachment means, such as a port configured on the outside 106 of the portable case 100, for mating with a corresponding component on the vehicle to securely couple thereto.

The portable case 100 may also be configured to have the shape of a receptacle inside the car so that it fits within the receptacle and is still removable by the user for transport in a handbag, backpack, or pocket, for example. The portable case 100 may therefore be embodied as a removable part of a permanent fixture in a vehicle. It is contemplated that many other means for accomplishing a charge of the main battery 120 may be implemented with the portable case 100, and are therefore within the scope of the present invention. Similarly, many approaches may be implemented for re-charging the auxiliary battery 131, and are also with scope of the present invention. For example, the present invention may include one or more charging components 130 configured to convey a charge from the auxiliary battery 131 to the main battery 120 from kinetic movement of the portable case 100, so that when the wearable electronic and/or computing device 110 is placed within the receptacle 102 and the portable case 100 experiences movement, the kinetic activity actuates a re-charge of the main battery 120. The present invention may also be configured to re-charge the auxiliary battery 131 inside the portable case 100 kinetically, so that movement generates a recharge of the portable case 100 recharging the auxiliary battery 131.

In another example the present invention may include charging components 130 that couple to solar panels positioned on the outside 106 of the portable case 100. The solar panels produce current when exposed to sources of light that the charging components 130 convert to convey a charge from the auxiliary battery 131 to the main battery 120, so that when the wearable computing device 110 is placed within the receptacle 102, the solar panels automatically re-charge the main battery 120. The present invention may also be configured to recharge the auxiliary battery 131 inside the portable case 100 from the solar panels, so that the portable case 100 itself is recharged when exposed to light sources.

The wireless charging components 174 of the additional circuitry 170 may be configured to accomplish wirelessly charging inductively, using an electromagnetic field to transfer a charge between the auxiliary battery 131 and the main battery 120 on the wearable electronic and computing device 110. The wireless components 174 may be configured to form an inductive coupling between the auxiliary battery 131 and the main battery 120, and therefore may include at least inductive coil.

The present invention may also include one or more mobile applications that are resident on mobile devices such as “smart” phones or tablets. A mobile application may be linked to the portable case 100 to provide alerts to users of wearable and electronic computing devices 110 as to how much power is left in the both the main battery 120 and the auxiliary battery 131, as well as other alerts such as how much time remains until either the device 110 or the portable case 100 runs out of power, estimated time of day that the main battery 120 and auxiliary battery 131 will run out of power, battery health, battery temperature, CPU, RAM, and other memory usage, and the like.

Accordingly, the portable case 100 may have one or more on-board software and hardware components configured to communicate with such mobile application(s) resident of external mobile devices. For example, the portable case may be configured with software that sends data to the mobile application(s) with updates regarding how much power is left in the both the main battery 120 and the auxiliary battery 131, as well as other alerts as discussed above.

The external port 141 on the portable case 100 may comprise an auxiliary outlet, USB port, or other means that can provide a charge to another device. This configuration enables a user to connect a mobile device, for example a mobile phone, music player, tablet, gaming headset, or any other such device, and charge that device from the portable case 100 while the user's wearable and/or electronic computing device 110 is in the receptacle 102 and also charging. Therefore this enables users to connect mobile devices to the portable case 100 and charge that device and the wearable electronic and computing device 110 simultaneously.

1. An apparatus, comprising:
(a) a receptacle within an inside area of a portable case configured to receive and store an optical computing device having a main battery;
(b) an auxiliary battery embedded within at least a portion of the receptacle; and
(c) at least one electrical contact within the receptacle, the electrical contact being operable to electrically connect the auxiliary battery to the optical computing device so that power from the auxiliary battery may be applied to re-charge the main battery when the optical computing device is stored within the receptacle.

2. The apparatus of claim 1, wherein the optical computing device comprises eyewear having a head-mounted display.

3. The apparatus of claim 1, further comprising a charging cable that connects the auxiliary battery to the optical computing device, wherein the electrical contact within the receptacle is attached to the charging cable so that the main battery can be charged where a charging port on the optical computing device and the electrical contact are located in different places upon insertion of the optical computing device into the portable case, and an extension cable that lengthens the connection between the optical computing device and the auxiliary battery, so that the optical electronic computing device may be used while the auxiliary battery is charging the main battery.

4. The apparatus of claim 1, wherein the auxiliary battery is housed in a second receptacle within the portable case so that the auxiliary battery is removable from the portable case.

5. The apparatus of claim 1, further comprising a means for charging the optical computing device from an external power source, wherein the means for charging is a charging device having a cable configured to plug into at least one of a computer and a conventional power outlet to convey charge to the optical computing device from the at least one of a computer and a conventional power outlet.

6. The apparatus of claim 1, further comprising a data cable configured to transfer and synchronize data between a computer and optical computing device.

7. The apparatus of claim 1, further comprising a cable configured to connect with an external computer and convey power to the optical computing device from the external computer, and transfer and synchronize data between the external computer and optical computing device.

8. The apparatus of claims 1, further comprising a battery status mode in which a plurality of light emitting diodes display an indication of battery strength and charging status that is visible on the outside of the portable case.

9. The apparatus of claim 1, further comprising a plurality of wireless components that wirelessly charge one or both of the main battery and the auxiliary battery.

10. The apparatus of claim 1, further comprising an auxiliary memory component disposed within the portable case to supplement memory included in the optical computing device, and a second electrical contact within the receptacle and operable to electrically connect the auxiliary memory component to the optical computing device.

11. The apparatus of claim 1, further comprising a heat dissipating component disposed within the receptacle.

12. The apparatus of claim 1, wherein the optical computing device comprises headgear worn by a user while actuating an electronic game.

13. The apparatus of claim 1, further comprising one or more modules configured to communicate data about the optical computing device to a remote mobile application.

14. The portable recharging device of claim 1, further comprising an external port accessible from an outside of the portable case, the external port configured to charge a second device using the auxiliary battery.

15. A portable recharging device for electronic eyeglasses, comprising:
(a) an auxiliary battery disposed within a receptacle of a portable case that receives and stores electronic eyeglasses having a main battery;
(b) charging and heat dissipation circuitry configured to 1) electrically connect the auxiliary battery to the electronic eyeglasses so that a charge of the auxiliary battery is applied to the main battery while stored within the portable case, and 2) dissipate heat while the charge of the auxiliary battery is applied to the main battery while stored within the portable case; and
(c) one or more modules configured to supplement a memory storage capability of the electronic eyeglasses.

16. The portable recharging device of claim 15, wherein the charging and heat dissipation circuitry includes a fan.

17. The portable recharging device of claim 15, wherein the charging and heat dissipation circuitry includes means for charging the electronic eyeglasses from an external power source.

18. The portable recharging device of claim 17, wherein the external power source is an external computer, and the means for charging is a charging device configured to convey charge to the electronic eyeglasses from the external computer via a cable coupled to the portable case at an external port on the outside of the portable case.

19. The portable recharging device of claim 15, further comprising a data cable configured to transfer and synchronize data with the electronic eyeglasses.

20. The portable recharging device of claim 15, further comprising an indication of battery strength and charging status comprising a plurality of light emitting diodes visible on an outside of the portable case.

21. The portable recharging device of claim 15, wherein the charging and heat dissipation circuitry a plurality of wireless components that wirelessly charge one or both of the main battery and the auxiliary battery.

22. The portable recharging device of claim 15, wherein the auxiliary battery is removably disposed within a second receptacle inside the portable case.

23. The portable recharging device of claim 15, further comprising one or more additional modules configured to communicate data about the electronic eyeglasses to a remote mobile application.

24. The portable recharging device of claim 15, further comprising an external port accessible from an outside of the portable case, the external port configured to charge a second device using the auxiliary battery.

25. An apparatus for charging a wearable electronic device, comprising:
(a) a receptacle within an inside area of a portable case configured to receive and store a wearable electronic device having a main battery;
(b) an auxiliary battery embedded within at least a portion of the receptacle; and
(c) at least one electrical contact within the receptacle, the electrical contact being operable to electrically connect the auxiliary battery to the wearable electronic device so that power from the auxiliary battery may be applied to re-charge the main battery when the wearable electronic device is stored within the receptacle.

26. The apparatus of claim 25, wherein the wearable electronic device is a pair of electronic eyeglasses.

27. The apparatus of claim 25, wherein the wearable electronic device is a wristwatch.
